(19) United States
(12) Patent Application Publication
(10) Pub. No.: US 2002/0142261 A1
(43) Pub. Date: Oct. 3, 2002

(54) Filling element for use in a root canal treatment

(76) Inventor: Andreas Adrianus Lambertus Van Den Houdt, Beuningen (NL)

Correspondence Address: YOUNG & THOMPSON, 745 SOUTH 23RD STREET 2ND FLOOR, ARLINGTON, VA, 22202

(21) Appl. No.: 09/820,786

(22) Filed: Mar. 30, 2001

(51) Int. Cl. A61C 5/02

(52) U.S. Cl. 433/81; 433/224; 433/32

(57) ABSTRACT

A filling element for use in a root canal treatment, which treatment comprises the removal of the nerve from the root canal, machining the walls of the root canal and inserting a thermoplastic material in the root canal, which thermoplastic material is able when warm to adapt to the shape of the root canal such that no open spaces remain therein, comprises a support as well as a coating of the thermoplastic material on said support. The support comprises an element that can be electrically heated.

The invention relates to a filling element for use in a root canal treatment, which treatment comprises the removal of the nerve from the root canal, machining the walls of the root canal and inserting a thermoplastic material in the root canal, which thermoplastic material is able when warm to adapt to the shape of the root canal such that no open spaces remain therein, which filling element comprises a support as well as a coating of the thermoplastic material on said support.

Various embodiments of such filling elements are known. According to a first embodiment, known under the trade name “Thermafill”, the filling element has a plastic core, provided with a grip, around which core a coating of gutta percha has been applied. After this filling element has been heated, for example in an oven, it is placed in the root canal where, as a consequence of the heat, the thermoplastic material is pressed such that it comes into good contact with the wall of the root canal and all capillaries therein. The protruding part of the core, including the grip, is then cut off using a tool and the excess thermoplastic material is also removed. The remainder of the core therefore remains behind in the root canal, together with the thermoplastic material.

According to a second embodiment sticks are used which consist entirely of thermoplastic material (gutta percha). Using an instrument, which may or may not be heated, this material can then be inserted in the root canal in various ways.

These and other known embodiments have certain disadvantages. That part of the core that remains behind in the root canal in the case of the first embodiment constitutes a foreign element that is difficult to remove afterwards. The disadvantage of the other embodiments is that applying the thermoplastic material layer by layer is labour-intensive. This method is consequently expensive and, moreover, demands high skill.

The aim of the invention is therefore to provide a filling element that does not have these disadvantages. Said aim is achieved in that the support comprises an element that can be heated electrically and that, after inserting the filling element, can be removed leaving the thermoplastic material behind.

The filling element according to the invention having an element that can be heated electrically has various advantages. First of all heating of the thermoplastic material can be carried out efficiently. Specifically, the element can release the heat generated directly to the thermoplastic coating.

A further advantage is that the filling element can be placed in the root canal before it has been heated. This simplifies manipulation and is also safer. After positioning the filling element, the element can be connected to an electrical power source and the plastic material brought to the desired temperature.

The element can then be withdrawn from the heated thermoplastic coating, it being possible to hold back the coating, for example using an instrument. Finally, the thermoplastic mass that is still warm throughout can be pressed well into the root canal.

The filling element according to the invention combines the advantage of simple and rapid insertion into the root canal with the advantage that the root canal can be completely filled with gutta percha, without foreign elements remaining behind therein.

The support of the filling element can be constructed in various ways. Thus, for example, it can comprise a resistance wire which on applying an electric voltage exhibits a rise in temperature for heating the coating of thermoplastic material.

Preferably, the support comprises an electrical conductor that together with the resistance wire extends through the coating, which conductor and resistance wire can be insulated with respect to one another with the exception of their electrically conducting ends attached to one another. The electrically conducting ends of the conductor and the resistance wire attached to one another are at the distal end of the coating and emerge through the coating at the proximal end. An electric voltage can be applied at the proximal end, as will be explained below.

To facilitate the removal of the element, without the heated thermoplastic material being removed at the same time, a disc-shaped element through which the conductor and the resistance wire protrude with a close fit can be present at the proximal end of the coating. Using a dental instrument, the disc, which preferably consists of a flexible material such as rubber, can be held back whilst the element is pulled out and removed.

A connector to which the conductor and the resistance wire are fixed such that they are electrically conducting, which connector can be connected to a power source, and a coupling piece that can be mechanically attached to a treatment instrument can also be present at the proximal end.

The conductor and the resistance wire can be held together in various ways to provide a support. According to a first possibility, the conductor and the resistance wire are arranged concentrically around one another incorporating an insulating layer between them. The conductor can be a solid wire with an insulating coating, on which insulating coating a coating of resistance material is accommodated.

According to a second possibility, the conductor and the resistance wire are wound (twisted) around one another incorporating an insulating layer between them. In this case also the conductor can be a solid wire with an insulating coating around which the resistance wire has been wound.

The invention also relates to the combination of a filling element which is provided at the proximal end with a connector and with a coupling piece, as well as a treatment instrument which can be held in the hand and has an electrical counter-connector and a counter-coupling piece. Before the start of the root canal treatment a new filling element can always be fitted on the treatment instrument. The filling element can then be placed in position and then heated by switching on the electrical power source of the treatment instrument. As an alternative, the treatment instrument can comprise a treatment element and a holder which can be coupled to one another mechanically and electrically, and the counter-connector and the counter-coupling piece are located on the treatment element.

Finally, the invention relates to a method for carrying out a root canal treatment, comprising:

removal of the nerve from the root canal,

preparation of the root canal,

positioning a filling element as described above in the root canal from which the nerve has been removed,

electrically heating the coating of thermoplastic material by applying an electric voltage across the support,

removal of the element from the heated thermoplastic material, leaving said material behind in the root canal,

pressing in the thermoplastic material, which is still warm throughout, such that the cavity produced by the removal of the support is filled.

The invention will now be explained in more detail with reference to a few illustrative embodiments shown in the figures.

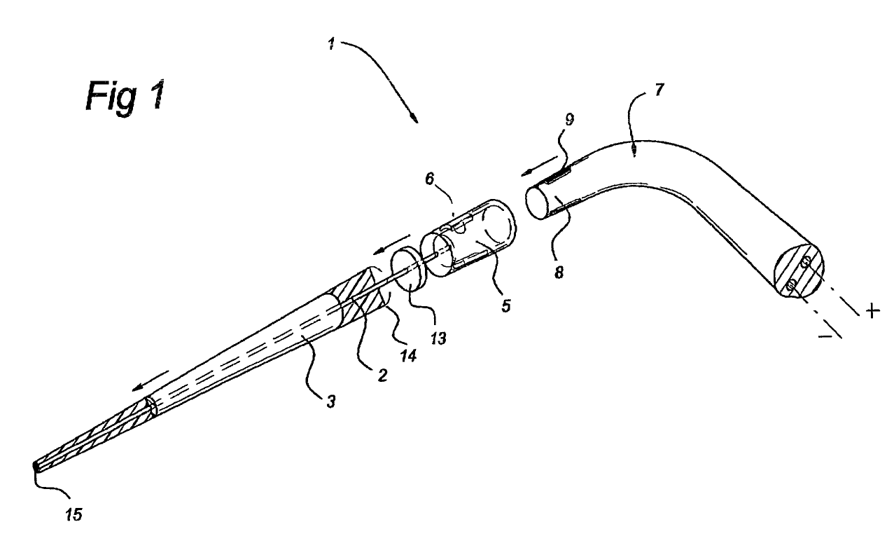

FIG. 1 shows a partially exploded perspective view of a filling element according to the invention.

FIG. 2 shows a detail, partially in section, of a first embodiment of the support of the filling element according to the invention.

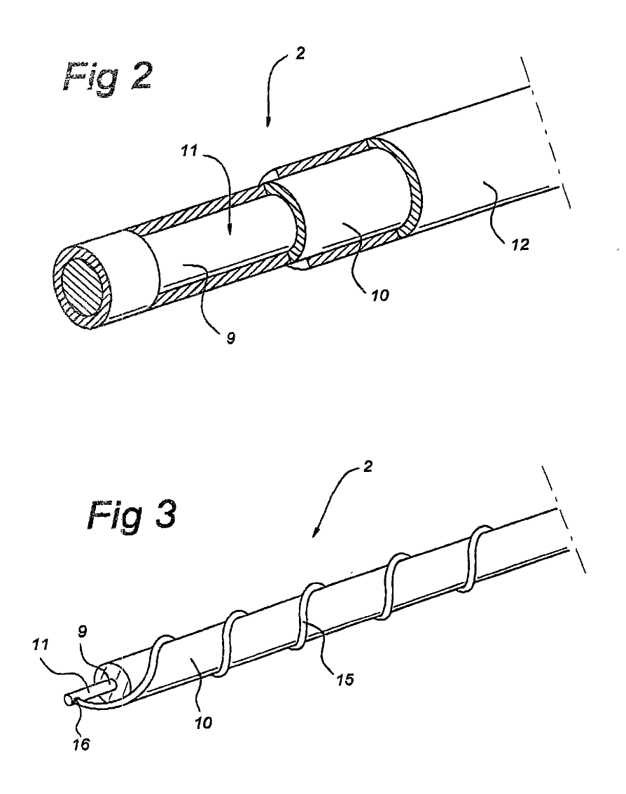

FIG. 3 shows a detail of a second support.

The filling element 1 shown in FIG. 1 for use in a root canal treatment comprises a support 2 that is coated with a thermoplastic material 3, such as gutta percha. The support 2 is attached to a coupling piece 5, on which a connector 6 is also located.

By means of the coupling piece 5 the filling element can be attached to a treatment element 7, part of which is shown in FIG. 1. This treatment element 7 comprises a counter-coupling piece 8 and a counter-connector 9.

In use, the filling element 1 is attached to the treatment element 7 by sliding the coupling piece 5 and the counter-coupling piece 8 onto one another. This brings the connector 6 into electrical connection with the counter-connector 9. An electric current can be fed to the support 2 via this connector 6 and counter-connector 9, which electric current can originate from a treatment instrument (not shown) with a power source, to which instrument the treatment element 7, shown in part, is attached.

In order to obtain a heating effect from the support 2 the latter can be constructed in various ways. A first possible embodiment is shown partially in perspective in section in FIG. 2. The support 2 shown in FIG. 2 has a conducting core 9, over the major proportion of which an insulating coating 10 has been applied. The insulating coating 10 is missing from the conducting core 9 only at the end 11. The core can also be joined to the coating by means of fusion or by applying a conducting material.

A conducting coating 12 of resistance material is applied on top of the insulating coating 10 and the protruding section 11 of the conducting core 9. The conducting core 9 and the conducting coating 12 are each connected to part of the connector 6.

When in operation, a current runs through the conducting core 9 and the conducting coating made of resistance material and heat is generated in the resistance material, as a result of which the temperature of the support 2 rises. The thermoplastic coating 3 of the filling element is heated as a result.

This heating can be started after the filling element 1 has been introduced into a root canal. In the heated state, when the thermoplastic material has become soft, the support 2 can then be removed. To allow this removal to proceed properly, a disc 13 of flexible material is arranged on the proximal end 14 of the coating 3. This disc 13 can be held back by means of a dental instrument when the support 2 is pulled out of the softened, heated thermoplastic material of the coating.

In this way it is possible in a simple, efficient manner to introduce a correct amount of gutta percha into the correct position in the root canal and make it thermoplastic (molten) throughout, whilst no foreign elements remain behind in the root canal after the support 2 has been removed.

In the variant in FIG. 3 the support 2 is again provided with an electrical conductor 9, the major proportion of which is coated with an insulating material. The distal end 11 of the conductor 9 protrudes slightly from the coating 10. A resistance wire 15 is wound around the coating 10, which resistance wire 15 is attached by means of, for example, a laser weld 16 to the distal end 11 of the conductor 9. The resistance wire 15 and the conductor 11 are each fixed to one of the parts of the connector 6.

1. Filling element (1) for use in a root canal treatment, which treatment comprises the removal of the nerve from the root canal, machining the walls of the root canal and inserting a thermoplastic material in the root canal, which thermoplastic material is able when warm to adapt to the shape of the root canal such that no open spaces remain therein, which filling element (1) comprises a support (2) as well as a coating (3) of the thermoplastic material on said support (2), characterised in that the support (2) comprises an element (12, 15) that can be electrically heated.

2. Filling element according to claim 1, wherein the support (2) comprises a resistance wire (12, 15) which on applying an electric voltage exhibits a rise in temperature for heating the coating (3) of thermoplastic material.

3. Filling element according to claim 2, wherein the support (2) comprises an electrical conductor (9, 11) that together with the resistance wire (12, 15) extend through the coating (3), which conductor (9, 11) and resistance wire (12, 15) are insulated with respect to one another with the exception of their electrically conducting ends (11) attached to one another.

4. Filling element according to claim 3, wherein the electrically conducting ends (11) of the conductor (9, 11) and the resistance wire (12, 15) attached to one another are at the distal end (15) of the coating (3) and emerge through the coating (3) at the proximal end (14).

5. Filling element according to claim 4, wherein a disc-shaped element (13) through which the conductor (9, 11) and the resistance wire (12, 15) protrude with a close fit is present at the proximal end (14) of the coating (3).

6. Filling element according to claim 5, wherein a connector (6) to which the conductor (9, 11) and the resistance wire (12, 15) are fixed such that they are electrically conducting, which connector (6) can be connected to a power source, is present at the proximal end (14).

7. Filling element according to claim 6, wherein a coupling piece (5) that can be mechanically attached to a treatment instrument (7) is also present at the proximal end (14).

8. Filling element according to claim 3, 4, 5, 6 or 7, wherein the conductor (11) and the resistance wire (12) are arranged concentrically around one another incorporating an insulating layer (10) between them.

9. Filling element according to claim 8, wherein the conductor (9) is a solid wire with an insulating coating (10), on which insulating coating (10) a coating (12) of resistance material is accommodated.

10. Filling element according to claim 3, 4, 5, 6 or 7, wherein the conductor (9) and the resistance wire (15) are wound (twisted) around one another incorporating an insulating layer (10) between them.

11. Filling element according to claim 10, wherein the conductor (9) is a solid wire with an insulating coating (10) around which the resistance wire (15) has been wound.

12. In combination, a filling element according to claim 7, which is provided at the proximal end (14) with a connector (6) and with a coupling piece (5), as well as a treatment instrument (7) which can be held in the hand and has an electrical counter-connector (9) and a counter-coupling piece (8).

13. Combination according to claim 12, wherein there is an electrical power source in the treatment instrument.

14. Combination according to claim 12 or 13, wherein the treatment instrument comprises a treatment element (7) and a holder which can be coupled to one another mechanically and electrically, and the counter-connector (9) and the counter-coupling piece (8) are located on the treatment element (7).

15. Method for carrying out a root canal treatment, comprising:
removal of the nerve from the root canal,
preparation of the root canal,
positioning a filling element (1) according to one of claims 1-12 in the prepared root canal from which the nerve has been removed,
electrically heating the coating (3) of thermoplastic material by applying an electric voltage across the element (2) that can be heated electrically,
removal of the element (2) from the heated thermoplastic material (3), leaving said material (3) behind in the root canal,
pressing in the warm thermoplastic material such that the cavity produced by the removal of the element (2) is filled.
